(19) United States
(12) Patent Application Publication
(10) Pub. No.: US 2026/0327030 A1
(43) Pub. Date: Oct. 22, 2026

(54) SHEET FEEDING APPARATUS, IMAGE READING APPARATUS, AND IMAGE FORMING APPARATUS

(71) Applicant: CANON KABUSHIKI KAISHA, Tokyo (JP)

(72) Inventor: MASANORI HIRONISHI, Tokyo (JP)

(21) Appl. No.: 19/636,281

(22) Filed: Apr. 1, 2026

(30) Foreign Application Priority Data
Apr. 16, 2025 (JP) 2025-067551

(51) Int. Cl. B65H 7/02; H04N 1/00

(52) U.S. Cl. CPC B65H 7/02; H04N 1/00549; H04N 1/00694; H04N 1/00824

(57) ABSTRACT

An automatic document feeder (ADF) includes a sensor that detects the presence or absence of a document on a document tray, an elimination device that eliminates chattering of a signal output from the sensor, and a central processing unit (CPU). In a case where signals from the sensor consecutively remain the same a first predetermined number of times, the elimination device transmits a signal indicating a state of the sensor, to the CPU. In a case where signals from the elimination device consecutively remain the same a second predetermined number of times, the CPU 301 determines information indicating the presence or absence of a sheet on the document tray.

### BACKGROUND

### Field of the Technology

The aspect of the embodiments relates to a sheet feeding apparatus that feeds a sheet, and an image reading apparatus and image forming apparatus that include the sheet feeding apparatus.

### Description of the Related Art

An image forming apparatus and an image reading apparatus that include a sheet feeding apparatus that feeds a sheet from a feeding tray have been conventionally known. Such a sheet feeding apparatus includes a sheet detection sensor that detects a sheet on the feeding tray. Japanese Patent Laid-Open No. 2017-158027 describes a sheet detection sensor configured to detect a sheet on a feeding tray by a swinging member that swings by being pressed by the sheet placed on the feeding tray, blocking light from a light emission unit to a light receiving unit of a photointerrupter.

On the other hand, depending on an environment where an apparatus is installed, the fluctuation (chattering) of a signal from the sheet detection sensor to a control unit is sometimes caused by radiated noise from the outside of the apparatus. For example, in a case where another machine generating radiated noise is installed near the apparatus, such signal fluctuation might occur. In this manner, if the fluctuation of a signal output from the sheet detection sensor occurs, erroneous detection in which the control unit determines that a sheet is placed might occur, although no sheet is placed on the feeding tray.

### SUMMARY

According to an aspect of the embodiments, an apparatus includes a feeding tray on which a sheet is to be placed, a feeding member configured to feed a sheet placed on the feeding tray, a sensor configured to detect presence or absence of a sheet on the feeding tray, an elimination device configured to eliminate chattering of a signal to be output by the sensor, and a controller configured to control the feeding member based on presence or absence of a sheet on the feeding tray, wherein the sensor includes an emission unit, a receiving unit that receives light from the emission unit, and a swinging member that swings by being pressed by a sheet placed on the feeding tray, and transmits, to the elimination device, a signal indicating which of a state in which the swinging member blocks light from the emission unit to the receiving unit, and a state in which the swinging member does not block light from the emission unit to the receiving unit, wherein the elimination device cyclically acquires a signal from the sensor at a first cycle, and in a case where signals from the sensor consecutively remain the same a first predetermined number of times equal to or larger than two, the elimination device executes first processing of transmitting a signal from the sensor to the controller, and wherein the controller cyclically acquires a signal from the elimination device at a second cycle, and in a case where signals from the elimination device consecutively remain the same a second predetermined number of times equal to or larger than two, the controller executes second processing of determining information indicating presence or absence of a sheet on the feeding tray.

Features of the disclosure will become apparent from the following description of embodiments with reference to the attached drawings. The following description of embodiments is described by way of example.

### BRIEF DESCRIPTION OF THE DRAWINGS

FIG. 1 is a cross-sectional view of an image forming apparatus.

FIG. 2 is a perspective view of an image reading apparatus.

FIG. 3 is a cross-sectional view of the image reading apparatus.

FIG. 4 is a plan view of an operation unit.

FIG. 5 is a block diagram illustrating a control configuration of the image reading apparatus.

FIG. 6A is a diagram illustrating a document detection sensor viewed from a width direction. FIG. 6B is a diagram illustrating the document detection sensor viewed from a feeding direction.

FIG. 7 is a flowchart illustrating a document feeding-reading control.

FIG. 8A is a flowchart illustrating a flow of the entire document detection processing. FIG. 8B is a flowchart illustrating first document detection processing. FIG. 8C is a flowchart illustrating second document detection processing.

FIG. 9 is a diagram illustrating a setting screen according to a modified example.

FIG. 10 is a diagram illustrating a setting screen according to a modified example.

FIG. 11A illustrates an electric signal to be output by the document detection sensor in a case where no influence is exerted from an external environment. FIG. 11B illustrates a document detection result to be obtained by a central processing unit (CPU) in a case where no influence is exerted from an external environment. FIG. 11C illustrates an electric signal to be output by the document detection sensor in a case where an influence is exerted from an external environment. FIG. 11D illustrates a document detection result to be obtained by a CPU in a case where an influence is exerted from an external environment. FIG. 11E illustrates a document detection result to be obtained by a CPU in a case where document detection processing according to the present embodiment is executed.

### DESCRIPTION OF THE EMBODIMENTS

Hereinafter, an embodiment of the present disclosure will be described with reference to the accompanying drawings.

### Image Forming Apparatus

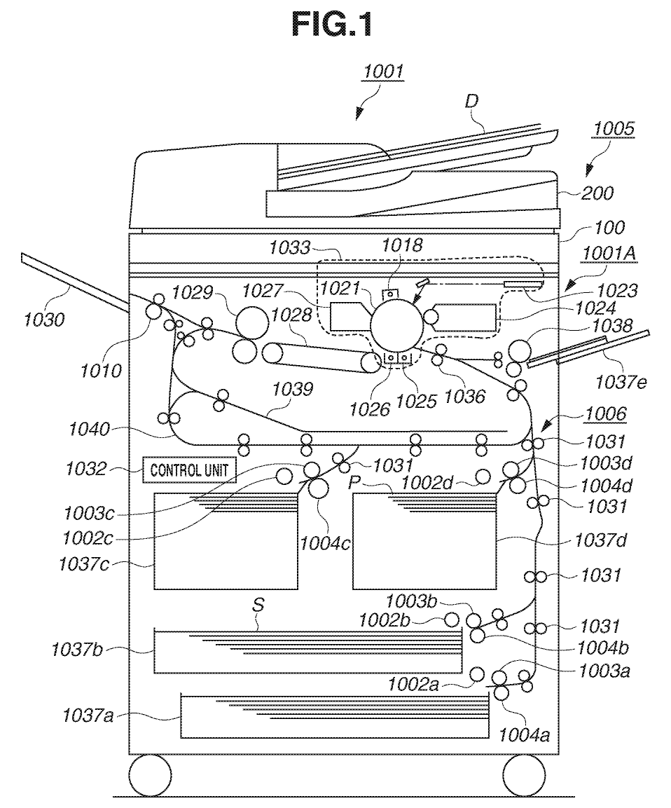

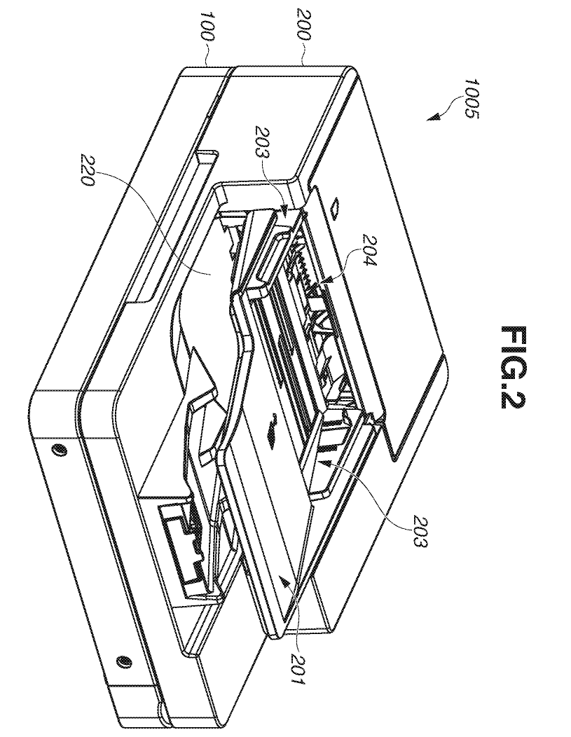

FIG. 1 is a cross-sectional view illustrating a configuration of an image forming apparatus including an image reading apparatus according to the present embodiment.

In an image forming apparatus 1001, an image reading apparatus 1005 is mounted on a printer 1001A, and the image forming apparatus 1001 is implemented by a copier, a facsimile apparatus, a multifunction printer, a multifunction peripheral (MFP), or the like, for example. The image forming apparatus 1001 includes an operation unit to be described below, as a user interface including an input interface and an output interface.

The image reading apparatus 1005 includes a scanner unit 100 and an automatic document feeder (hereinafter, will be referred to as an ADF) 200 that automatically conveys a document D. The ADF 200 is openably and closeably attached to the scanner unit 100. The scanner unit 100 reads an image from the document D by optically scanning the document D. The image reading apparatus 1005 transmits image data indicating a read image of the document D, to a control unit 1032 of the printer 1001A. By the control executed by the control unit 1032, the printer 1001A forms an image that is based on the acquired image data, on a sheet S being a recording medium.

The printer 1001A includes an image forming unit 1033 that forms an image on the sheet S, a sheet feeding unit 1006 that feeds the sheet S to the image forming unit 1033, and a fixing device 1029.

The sheet S is conveyed from the sheet feeding unit 1006 to the image forming unit 1033, an image is transferred thereto, and then, the image is fixed by the fixing device 1029 and the sheet S is discharged to a discharge tray 1030.

The sheet feeding unit 1006 includes a plurality of sheet accommodation units 1037a, 1037b, 1037c, and 1037d that can accommodate sheets S with the respective different sizes. The sheets S accommodated in the sheet accommodation units 1037a, 1037b, 1037c, and 1037d are fed from the sheet accommodation units 1037a, 1037b, 1037c, and 1037d by respective pickup rollers 1002a, 1002b, 1002c, and 1002d. The fed sheets S are separated one by one by respective feed rollers 1003a, 1003b, 1003c, and 1003d, and respective retard rollers 1004a, 1004b, 1004c, and 1004d, and conveyed to respective conveyance roller pairs 1031. By being sequentially delivered to a plurality of conveyance roller pairs 1031 arranged along a sheet conveyance path, the sheet S is conveyed to a registration roller pair 1036 provided on the sheet conveyance path.

The sheet feeding unit 1006 also includes a manual feed tray 1037e. The sheet S placed on the manual feed tray 1037e by a user is fed by a feeding roller 1038 into the printer 1001A, and conveyed to the registration roller pair 1036.

The registration roller pair 1036 corrects skew by stopping the leading end of the sheet S. The registration roller pair 1036 restarts the conveyance of the sheet S to the image forming unit 1033 in accordance with the progress of a toner image formation process executed by the image forming unit 1033.

The image forming unit 1033 according to the present embodiment is an electrophotographic device including a photosensitive drum 1021. The image forming unit 1033 may be configured to form an image using an inkjet method or an offset printing method, for example.

The photosensitive drum 1021 is a drum-shaped photosensitive member having a photosensitive layer on its surface, and is rotatable around a drum axis along a conveyance direction of the sheet S. A charging device 1018, an exposure device 1023, a development device 1024, a transfer charging device 1025, a separation charging device 1026, and a cleaner 1027 are arranged around the photosensitive drum 1021. The charging device 1018 uniformly charges the surface of the photosensitive drum 1021. The exposure device 1023 exposes the charged surface of the photosensitive drum 1021 based on image data acquired from the image reading apparatus 1005 or an external apparatus, and forms an electrostatic latent image on the photosensitive drum 1021.

The development device 1024 stores a two-component developer containing toner and a carrier. The development device 1024 supplies charged toner to the photosensitive drum 1021, and causes the toner to adhere to the electrostatic latent image. The electrostatic latent image is thereby developed, and a toner image is formed on the surface of the photosensitive drum 1021. The toner image borne on the photosensitive drum 1021 is transferred to the sheet S by a bias electric field formed by the transfer charging device 1025. The sheet S is conveyed from the registration roller pair 1036 to the transfer charging device 1025 in accordance with a timing at which a toner image is formed.

The sheet S bearing the transferred toner image is separated from the photosensitive drum 1021 by a bias electric field formed by the separation charging device 1026, and conveyed by a pre-fixing conveyance unit 1028 to the fixing device 1029. An adhering substance such as transfer residual toner remaining on the photosensitive drum 1021 without being transferred to the sheet S is removed by the cleaner 1027. Thus, the photosensitive drum 1021 can prepare for the next image forming operation.

The fixing device 1029 nips and conveys the sheet S by a roller pair. At this time, the fixing device 1029 melts and fixes the toner image to the sheet S by heating and pressing the sheet S. By the fixing of the toner image, image formation on the sheet S is completed. The sheet S on which an image is formed is discharged via a discharge roller pair 1010 to the discharge tray 1030 protruding toward the outside of the printer 1001A.

In the case of performing duplex printing, the sheet S bearing an image formed on one surface (first surface) is conveyed to a reversing unit 1039 after having passed through the fixing device 1029, to form an image on the other surface (second surface). An image formation surface of the sheet S is reversed by the reversing unit 1039 from the first surface to the second surface, and the sheet S is conveyed to a duplex conveyance unit 1040. The duplex conveyance unit 1040 conveys the sheet S with the reversed image formation surface to the registration roller pair 1036. The sheet S is conveyed from the registration roller pair 1036 to the image forming unit 1033, an image is formed on the second surface, and then, the sheet S is discharged to the discharge tray 1030.

### Image Reading Apparatus

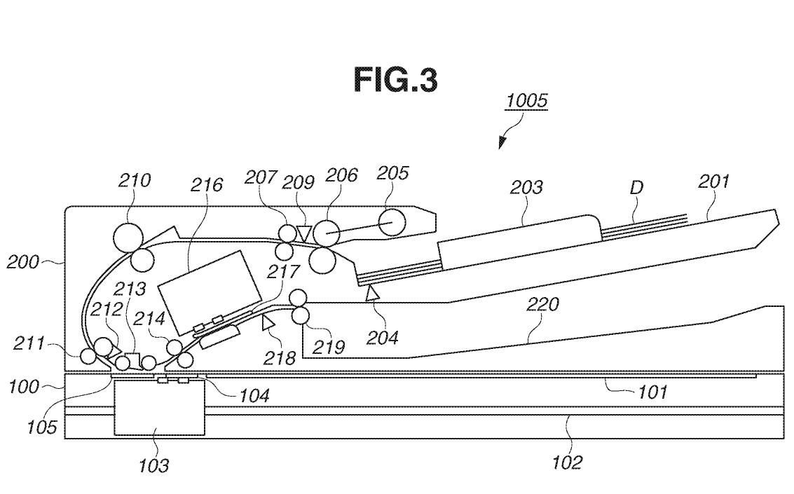

FIG. 2 is an external perspective view of the image reading apparatus 1005. FIG. 3 is a cross-sectional view of the image reading apparatus 1005. The scanner unit 100 includes a platen glass 101, a front surface document feeding-reading glass 105, and a white reference plate 104 on a surface (top surface) on which the ADF 200 is opened and closed, and incorporates a front surface reading unit 103 and a movement guide 102. The front surface reading unit 103 reads an image on one surface (front surface) of a document. The front surface reading unit 103 is movable along the movement guide 102 by an optical motor to be described below.

In a case where the conveyed document D is read using the ADF 200, the front surface reading unit 103 stops at a position below the front surface document feeding-reading glass 105, and performs image reading processing by reading an image on the conveyed document D line by line. Processing of reading the document D conveyed by the ADF 200 will be referred to as "document feeding-reading". In a case where a document placed on the platen glass 101 is read, the front surface reading unit 103 performs image reading processing by reading an image on the document D line by line while moving along the movement guide 102. Processing of reading a document placed on the platen glass 101 will be referred to as "document fixed reading". When shading correction of the front surface reading unit 103 is performed, the white reference plate 104 is read by the front surface reading unit 103. The white reference plate 104 is provided between the platen glass 101 and the front surface document feeding-reading glass 105.

The ADF 200 is a sheet conveyance apparatus (sheet feeding apparatus) that conveys the document D to a reading position for the scanner unit 100 reading an image from the document D. The ADF 200 includes a document tray 201 serving as a feeding tray on which a sheet-like document D is to be stacked. The ADF 200 conveys the document D placed on the document tray 201, up to a discharge tray 220 via a conveyance path. A plurality of documents D can be placed on the document tray 201. The document tray 201 includes two side regulating plates 203 arranged with facing each other in a width direction orthogonal to a feeding direction of the document D. The two side regulating plate 203 are movable in the width direction, and regulate the movement of the document D in the width direction by nipping the document D placed on the document tray 201. In the following description, upstream and downstream are based on the conveyance direction of the document D, and a conveyance source of the document D is upstream and a conveyance destination is downstream.

The ADF 200 can consecutively convey the documents D to a conveyance path one by one. On the conveyance path, various rollers for conveying the document D, and various sensors for detecting the document D are provided. The conveyance path includes, as a separation mechanism, a separation roller pair 206 that regulates the progress of the document D toward the downstream by the protrusion from the document tray 201 before a conveyance start, and a pickup roller 205. The document tray 201 is provided with a document detection sensor 204 for detecting the presence or absence of the document D on the document tray 201. The document detection sensor 204 is an example of a sheet detection sensor.

By rotating with being in contact with an uppermost surface of a bundle of the documents D stacked on the document tray 201, the pickup roller 205 feeds an uppermost document D to the conveyance path. The separation roller pair 206 separates and conveys one uppermost document D of the documents D fed by the pickup roller 205.

The document separation is performed by a known separation technique. For example, by rotating two rollers of the separation roller pair 206 in a reverse direction, document separation is performed. The pickup roller 205 and the separation roller pair 206 are driven by the same drive source. The separation roller pair 206 conveys the document D to a pull-out roller pair 207. The pickup roller 205 and the separation roller pair 206 serve as an example of a feeding member.

A separation sensor 209 is arranged on the downstream side of the separation roller pair 206. Based on a timing at which the separation sensor 209 detects the leading end of the document D, the conveyance of the document D is started by the pull-out roller pair 207, and the rotation of the pickup roller 205 and the separation roller pair 206 is stopped. The document D is conveyed by the pull-out roller pair 207, a conveyance roller pair 210, and a leading upstream roller pair 211 in this order. Similarly to the registration roller pair 1036, the conveyance roller pair 210 may perform skew correction of the document D. The leading upstream roller pair 211 conveys the document D onto the front surface document feeding-reading glass 105.

A leading sensor 212 is arranged upstream of the front surface document feeding-reading glass 105. In the case of reading the front surface of the document D, based on a timing at which the leading sensor 212 detects the leading end of the document D, the front surface reading unit 103 starts the reading of the document D. A document retaining member 213 is provided on the front surface document feeding-reading glass 105. The document D is read by the front surface reading unit 103 while passing through a space between the front surface document feeding-reading glass 105 and the document retaining member 213. The position of the front surface document feeding-reading glass 105 becomes a reading position where the document D is to be read by the front surface reading unit 103.

The document D having passed through the reading position of the front surface reading unit 103 is conveyed by a leading downstream roller pair 214. A rear surface document feeding-reading glass 217 is provided downstream of the leading downstream roller pair 214. A rear surface reading unit 216 for reading an image on the other surface (rear surface) of the document D is provided at a position facing the conveyance path across the rear surface document feeding-reading glass 217. When the document D is conveyed by the leading downstream roller pair 214 along the rear surface document feeding-reading glass 217 in the conveyance path, an image on the rear surface is read by the rear surface reading unit 216. In the case of reading the image on the rear surface of the document D, based on a timing at which the leading sensor 212 detects the leading end of the document D, the rear surface reading unit 216 starts the reading of the document D. The position of the rear surface document feeding-reading glass 217 becomes a reading position where the rear surface is to be read.

The document D of which the image is read from the rear surface is discharged by a discharge roller pair 219 to the discharge tray 220. In one embodiment, in a case where only an image on the front surface is to be read, image reading processing is not performed by the rear surface reading unit 216. After image reading processing performed by the front surface reading unit 103, the document D passes through the reading position of the rear surface reading unit 216 and is discharged to the discharge tray 220. A discharge sensor 218 is arranged between the rear surface document feeding-reading glass 217 and the discharge roller pair 219. In a case where no document D exists on the document tray 201, based on a timing at which the discharge sensor 218 detects the trailing end of the document D, after the discharge of the document D is completed, rollers for conveying the fed document D stop rotating. More specifically, the pull-out roller pair 207, the conveyance roller pair 210, the leading upstream roller pair 211, the leading downstream roller pair 214, and the discharge roller pair 219 stop rotating.

The front surface reading unit 103 and the rear surface reading unit 216 have the same configuration. Both the front surface reading unit 103 and the rear surface reading unit 216 include an optical system including a light source, a lens array, and the like, and a light receiving element. In the present embodiment, the light source is a light emitting diode (LED), and the light receiving element is a line sensor. The line sensor is implemented by, for example, a contact image sensor (CIS), a charge coupled device (CCD) image sensor including a reduction optical system that uses a mirror, or the like. The line sensor is arranged in the width direction of the document D. For this reason, a main scanning direction and a sub scanning direction of the front surface reading unit 103 and the rear surface reading unit 216 correspond to the width direction of the document D and the conveyance direction of the document D, respectively.

By the LED, the front surface reading unit 103 emits light to the document D passing along the front surface document feeding-reading glass 105 (front surface reading position). The light emitted by the LED is reflected by the front surface of the document D. The reflected light from the front surface of the document D is imaged by the optical system on a light receiving surface of the line sensor. In accordance with the imaged reflected light, the line sensor outputs image data indicating an image on the front surface of the document D. In this manner, the front surface reading unit 103 performs image reading processing of the front surface of the document D.

The rear surface reading unit 216 performs image reading processing in a case where duplex reading of the document D is set.

By the LED, the rear surface reading unit 216 emits light to the document D passing along the rear surface document feeding-reading glass 217 (rear surface reading position). The light emitted by the LED is reflected by the rear surface of the document D. The reflected light from the rear surface of the document D is imaged by the optical system on the light receiving surface of the line sensor. In accordance with the imaged reflected light, the line sensor outputs image data indicating an image on the rear surface of the document D. In this manner, the rear surface reading unit 216 performs image reading processing of the rear surface of the document D.

### Operation Unit

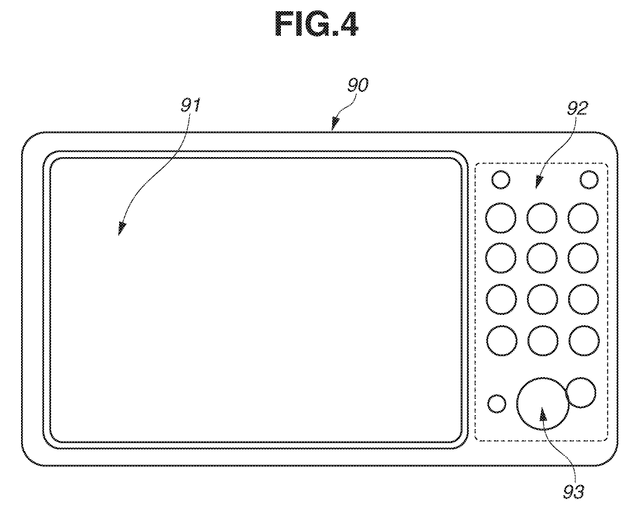

Next, an operation unit 90 of the image forming apparatus 1001 will be described. FIG. 4 is a top view of the operation unit 90. The operation unit 90 is arranged on the front side of the scanner unit 100, and receives an operation from the user. The operation unit 90 includes a display 91 serving as a display unit that displays information to the user, a keypad 92 including a plurality of hardware keys, a start button 93, and the like. The display 91 is a touch panel that displays information to the user, and is operable by the user through finger touch. Via the operation unit 90, the user can make various instructions and settings such as a reading start instruction and a print setting.

### Control Configuration

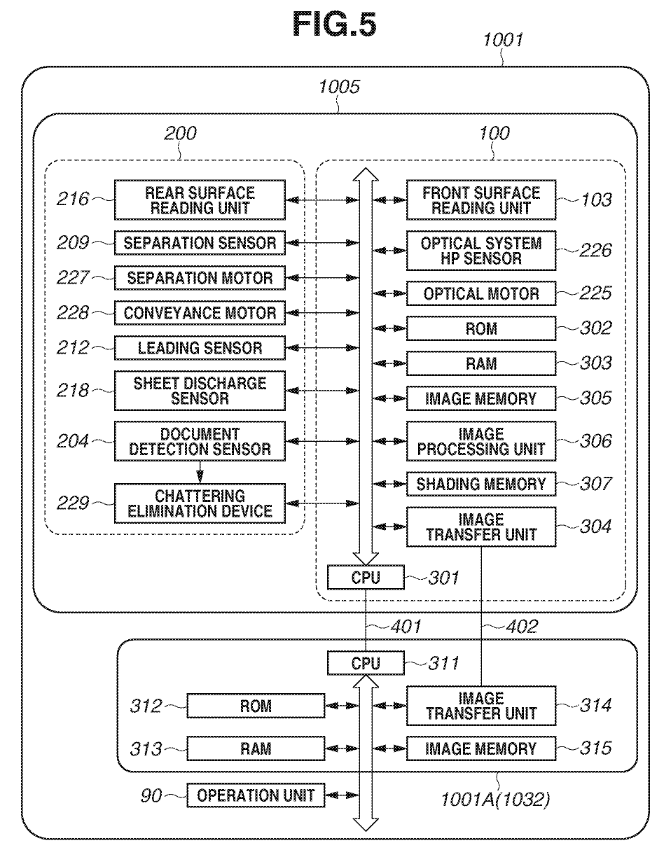

FIG. 5 is a block diagram illustrating a control configuration of the image forming apparatus 1001. The image reading apparatus 1005 includes a central processing unit (CPU) 301, a read only memory (ROM) 302, and a random access memory (RAM) 303. By executing a computer program stored in the ROM 302, the CPU 301 controls an operation of the entire image reading apparatus 1005. The RAM 303 provides a working area to be used when the CPU 301 executes processing. An image memory 305 and an image processing unit 306 are connected to the CPU 301. The CPU 301 is connected to the control unit 1032 arranged in the printer 1001A, in such a manner that communication can be performed. The CPU 301 is an example of a controller.

Motors and sensors arranged in the components of the image reading apparatus 1005, the front surface reading unit 103, and the rear surface reading unit 216 are connected to the CPU 301. The motors include a separation motor 227, a conveyance motor 228, and an optical motor 225. The separation motor 227 is a drive source for rotationally driving the pickup roller 205 and the separation roller pair 206, and feeding the documents D to a conveyance path one by one. The conveyance motor 228 is a drive source of rollers for conveying the document D to the conveyance path, such as the pull-out roller pair 207, the conveyance roller pair 210, the leading upstream roller pair 211, the leading downstream roller pair 214, and the discharge roller pair 219. The optical motor 225 is a drive source for moving the front surface reading unit 103 along the movement guide 102.

The sensors include the document detection sensor 204, the separation sensor 209, the leading sensor 212, the discharge sensor 218, and an optical system home position (HP) sensor 226. As described above, the document detection sensor 204, the separation sensor 209, the leading sensor 212, and the discharge sensor 218 are sensors for detecting a document at each position of the ADF 200. The optical system HP sensor 226 is a sensor for detecting that the front surface reading unit 103 is located at a home position (HP).

The document detection sensor 204 is connected to a chattering elimination device 229. The chattering elimination device 229 is a substrate for removing the fluctuation (chattering) of a signal of the document detection sensor 204. The chattering elimination device 229 is an example of a chattering elimination unit. An operation of the chattering elimination device 229 will be described below.

The CPU 301 stores image data output from the front surface reading unit 103 and the rear surface reading unit 216, into the image memory 305. In accordance with an image output request acquired from the control unit 1032 via a command data bus 401, the CPU 301 controls the image processing unit 306 to perform various types of image processing on the stored image data, and transmits the processed image data to the control unit 1032 via an image data bus 402. Furthermore, the CPU 301 transmits, to the control unit 1032 via the image data bus 402, a vertical synchronization signal serving as a reference of the leading end of the read image, and a horizontal synchronization signal serving as a reference of the leading end of pixels of one line of the read image, in accordance with a reading timing of a document.

The control unit 1032 is an information processing apparatus including a CPU 311, a ROM 312, a RAM 313, an image transfer unit 314, and an image memory 315. By executing a computer program stored in the ROM 312, the CPU 311 controls an operation of the entire image forming apparatus 1001 serving as an image formation system. The RAM 313 provides a working area to be used when the CPU 311 executes processing. The CPU 311 is connected to the CPU 301 of the image reading apparatus 1005 via the command data bus 401 in such a manner that communication can be performed, and performs transmission and reception of data related to image reading processing, in cooperation with the CPU 301. The image transfer unit 314 receives image data from an image transfer unit 304 of the image reading apparatus 1005, and stores the image data into the image memory 315.

The CPU 311 is connected to the above-described operation unit 90, and can receive an operation from the user. For example, the CPU 311 receives information such as instructions for monochrome reading and color reading, a reading resolution, a document size, and a reading job start instruction that are entered using the operation unit 90. Then, the CPU 311 transmits control information such as a document feeding start instruction and a document reading instruction to the CPU 301. The document feeding start instruction includes a reading resolution, and the document reading instruction includes information regarding a document size. In addition, the CPU 311 receives the state of the image reading apparatus 1005 from the CPU 301, and displays a message to the user that is suitable for the state of the apparatus, on the display 91 of the operation unit 90.

### Configuration of Document Detection Sensor

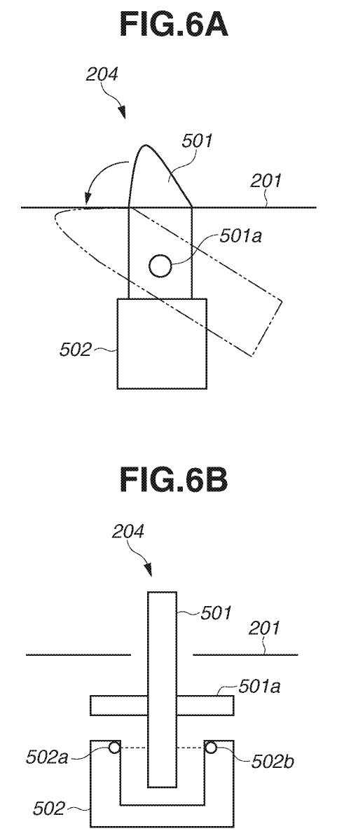

Next, a configuration of the document detection sensor 204 will be described with reference to FIGS. 6A and 6B. FIG. 6A is a perspective view illustrating the document detection sensor 204 viewed from the width direction. FIG. 6B is a diagram illustrating the document detection sensor 204 viewed from a feeding direction.

The document detection sensor 204 includes a flag member 501 and a photointerrupter 502. The flag member 501 is provided swingably (rotatably) around a shaft portion 501a, and its upper end portion is arranged in such a manner as to protrude from a surface of the document tray 201 on which a document is placed (placement surface, support surface). The shaft portion 501a extends in the width direction, and is supported by a support portion (not illustrated). If a document is placed on the document tray 201, the upper end portion of the flag member 501 is pressed by the document, and the flag member 501 swings to a position indicated by a dotted line in FIG. 6A.

As illustrated in FIG. 6B, the photointerrupter 502 includes a light emission unit 502a that emits light, and a light receiving unit 502b that receives light from the light emission unit 502a. In a case where no document is placed on the document tray 201, the flag member 501 enters a state of blocking an optical path from the light emission unit 502a to the light receiving unit 502b. If a document is placed on the document tray 201, the flag member 501 swings and enters a state of being retracted from the optical path from the light emission unit 502a to the light receiving unit 502b.

When the light receiving unit 502b receives light from the light emission unit 502a, the photointerrupter 502 outputs a predetermined signal. When the light receiving unit 502b does not receive light from the light emission unit 502a, the photointerrupter 502 does not output a signal. In other words, the photointerrupter 502 outputs a signal varying between a state in which the flag member 501 blocks the optical path from the light emission unit 502a to the light receiving unit 502b and a state in which the flag member 501 does not block the optical path from the light emission unit 502a to the light receiving unit 502b.

That is, a signal to be output by the photointerrupter 502 varies between a case where a document is placed on the document tray 201, and a case where no document is placed on the document tray 201. In this manner, by receiving a signal from the photointerrupter 502, the CPU 301 can determine the presence or absence of a document on the document tray 201.

In the document detection sensor 204 according to the present embodiment, the flag member 501 blocks the optical path from the light emission unit 502a to the light receiving unit 502b when a document is not placed, and the flag member 501 is retracted from the optical path from the light emission unit 502a to the light receiving unit 502b when a document is placed. Nevertheless, in contrast to this, the flag member 501 may be configured to be retracted from the optical path from the light emission unit 502a to the light receiving unit 502b when no document is placed, and block the optical path from the light emission unit 502a to the light receiving unit 502b when a document is placed.

### Document Feeding-Reading Control

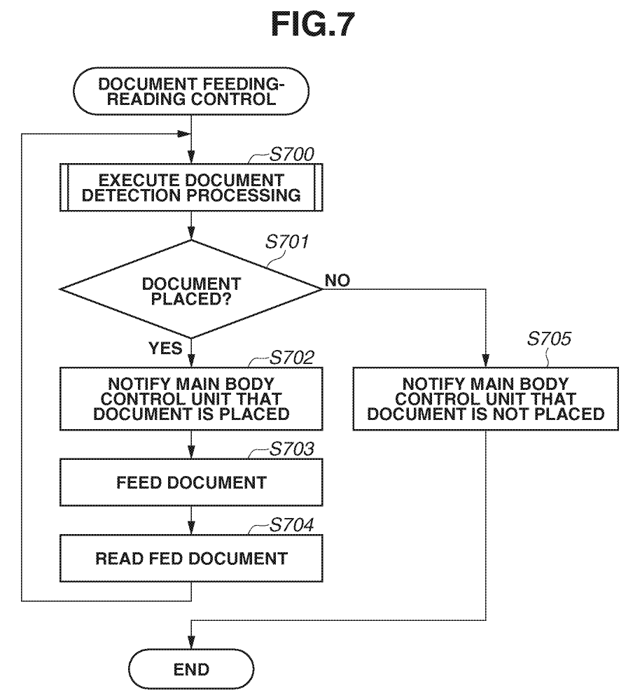

Document feeding-reading control to be executed by the CPU 301 of the image reading apparatus 1005 will be described with reference to FIG. 7. FIG. 7 is a flowchart illustrating document feeding-reading to be executed by the CPU 301 of the image reading apparatus 1005.

The document feeding-reading control is started by the CPU 301 receiving a reading start instruction from the control unit 1032. First of all, in step S700, the CPU 301 executes document detection processing of detecting the presence or absence of a document on the document tray 201. The document detection processing to be executed by the CPU 301 will be described below. In step S701, the CPU 301 determines whether a document is placed on the document tray 201, based on a result of the document detection processing. In a case where a document is placed on the document tray 201 (YES in step S701), the processing proceeds to step S702. In step S702, the CPU 301 notifies the control unit 1032 that a document is placed. In this case, in step S703, the CPU 301 feeds documents on the document tray 201 one by one, and in step S704, reads an image on the document by the front surface reading unit 103 and the rear surface reading unit 216. After that, the processing returns to step S700. In a case where no document is placed on the document tray 201 (NO in step S702), the processing proceeds to step S705. In step S705, the CPU 301 notifies the control unit 1032 that no document is placed, and ends the document feeding-reading control.

By the above-described control, in a case where a plurality of documents is placed on the document tray 201, until images on all the documents are read, the CPU 301 repeats document feeding and image reading (steps S702 to S704). In a case where no document is placed on the document tray 201 from the beginning, the CPU 301 executes document fixed reading.

### Description of Chattering in Document Detection

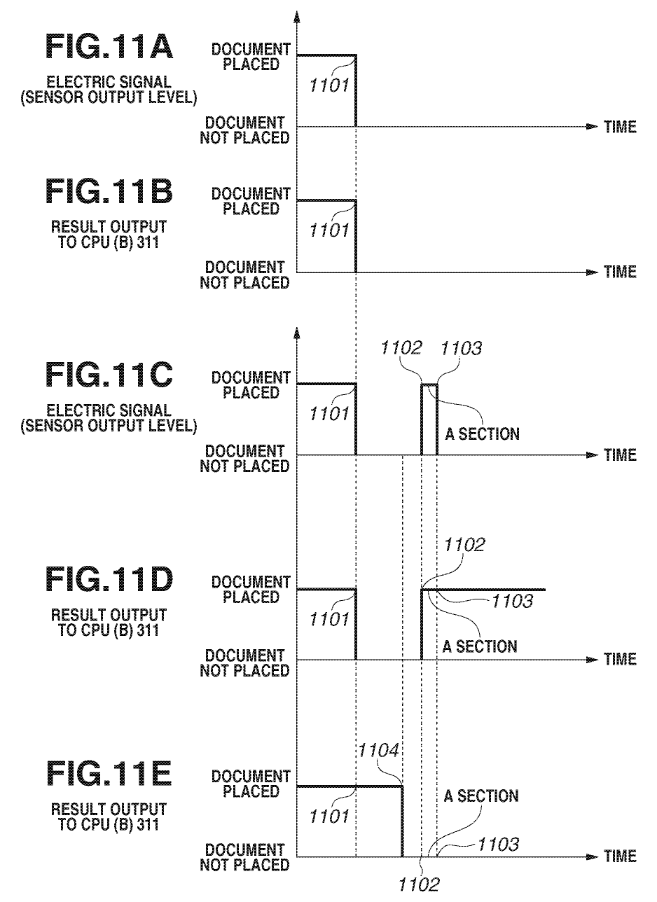

Here, an issue in document detection that uses a swinging member and a photointerrupter like the document detection sensor 204 will be described with reference to FIGS. 11A-11E. In FIGS. 11A-11E, the horizontal axis indicates time. Timings 1101 to 1103 illustrated in FIGS. 11A-11E indicate the same timings.

FIG. 11A illustrates a state (logic) indicated by an electric signal output by the document detection sensor 204 in a case where no influence is exerted from an external environment. In addition, FIG. 11B illustrates an output result transmitted by the CPU 301 to the CPU 311 in a case where no influence is exerted from an external environment. Specifically, FIG. 11B illustrates a waveform of a document detection result to be determined when the CPU 301 receives the logic in FIG. 11A from the document detection sensor 204. The timing 1101 indicates a timing at which the final document of a plurality of documents placed on the document tray 201 is fed. That is, the timing 1101 is a timing at which all documents are fed from the document tray 201, and a document on the document tray 201 has run out.

Up to the timing 1101, the document detection sensor 204 outputs a signal (ON) indicating that a document is placed, and after the timing 1101, the document detection sensor 204 outputs a signal (OFF) indicating that no document is placed, because a state in which no document is placed on the document tray 201 continues. For this reason, at the timing 1101, the CPU 301 detects that no document is placed, and notifies the CPU 311 that no document is placed. Then, normally, after the timing 1101, the CPU 301 neither detects that a document is placed, nor notifies the CPU 311 that a document is placed.

In contrast to this, FIG. 11C illustrates an example of an electric signal output by the document detection sensor 204 in a case where an influence is received from an external environment. For example, in a case where a machine that generates strong radiated noise is installed near the image forming apparatus 1001, an electric signal of the document detection sensor 204 is sometimes affected by the radiated noise.

Also in FIG. 11C, similarly to FIG. 11A, up to the timing 1101, the document detection sensor 204 outputs a signal indicating that a document is placed, and after the timing 1101, the document detection sensor 204 outputs a signal indicating that no document is placed. Nevertheless, due to the above-described influence from an external environment, the document detection sensor 204 sometimes outputs a signal indicating that a document is placed, although no document is placed on the document tray 201. In the example illustrated in FIG. 11C, at the timing 1102, a signal from the document tray 201 indicates that a document is placed, due to the influence from the external environment. Such fluctuation of a signal that is caused by the influence from the external environment will be referred to as chattering.

In the example illustrated in FIG. 11C, chattering occurs in an A section from the timings 1102 to 1103. In this example, a length from the timings 1101 to 1102 is 20 msec or more and 30 msec or less, and a length from the timings 1102 to 1103 is 0.4 μsec or more and 0.6 μsec or less, but these timings and times merely indicate an example.

FIG. 11D illustrates an output result transmitted by the CPU 301 to the CPU 311 in a case where the electric signal illustrated in FIG. 11C is received. Specifically, FIG. 11D illustrates a waveform of a document detection result to be determined when the CPU 301 receives the logic in FIG. 11C from the document detection sensor 204. By receiving logic indicating that no document is placed, from the document detection sensor 204 at the timing 1101, the CPU 301 notifies the CPU 311 that no document is placed. After that, by the document detection sensor 204 outputting logic indicating that a document is placed, at the timing 1102 due to the influence from the external environment, the CPU 301 notifies the CPU 311 that a document is placed. Here, a notification indicating that a document is placed that is to be issued by the CPU 301 at the timing 1102 is erroneous notification caused by chattering.

After that, even if the document detection sensor 204 outputs that no document is placed, at the timing 1103, because the CPU 311 has already been notified that a document is placed, the CPU 311 performs feeding control assuming that a document exists on the document tray 201. Nevertheless, because no document actually exists on the document tray 201, the CPU 311 makes erroneous determination indicating that an abnormality such as a jam has occurred.

In this manner, depending on an ambient environment where an apparatus is installed, a CPU sometimes erroneously determines the presence or absence of a document on a document tray. In view of the foregoing, the image reading apparatus 1005 according to the present embodiment reduces the occurrence of such erroneous determination by performing the following document detection processing.

### Document Detection Processing

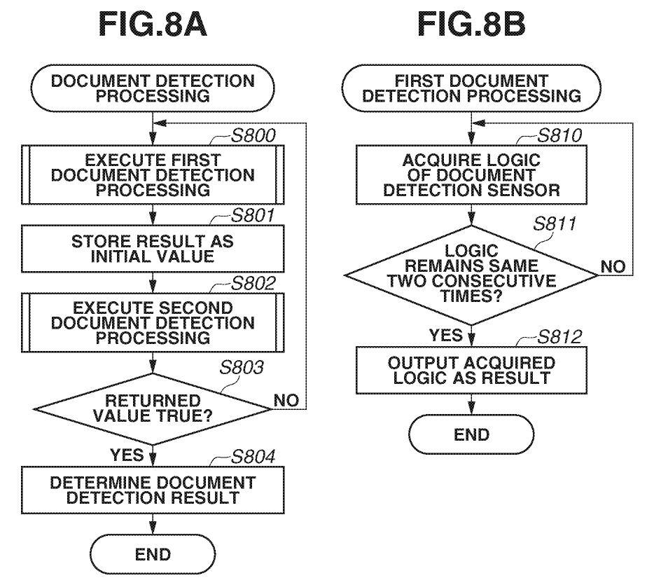

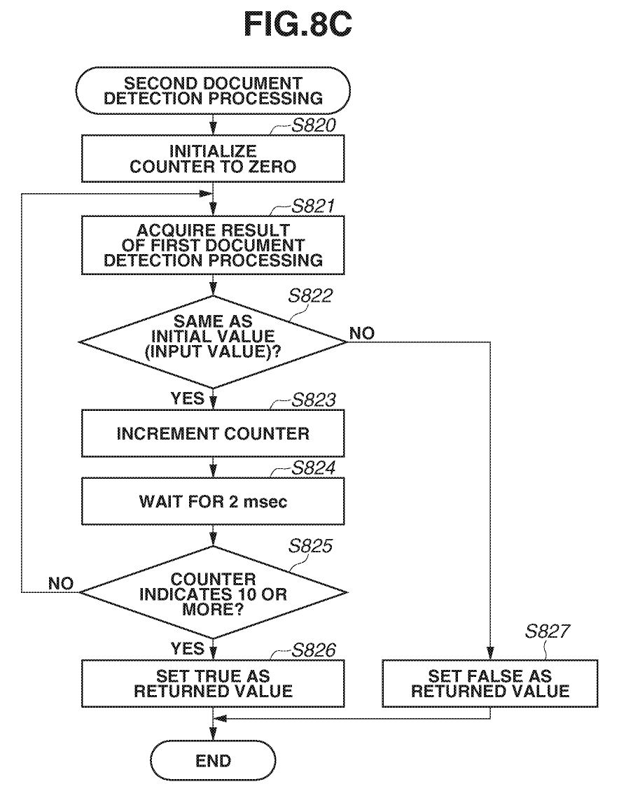

FIGS. 8A to 8C are flowcharts illustrating a series of flows of the document detection processing in step S700 of FIG. 7. FIG. 8A illustrates a flow of the entire document detection processing. The document detection processing illustrated in FIG. 8A includes first document detection processing and second document detection processing. FIGS. 8B and 8C indicate respective flows of the first document detection processing and the second document detection processing. The first document detection processing and the second document detection processing serve as respective examples of the first processing and the second processing.

First of all, a flow of the entire document detection processing illustrated in FIG. 8A will be described. In the document detection processing, first of all, in step S800, the CPU 301 acquires a document detection result by executing the first document detection processing. The details of the first document detection unit will be described below. Next, in step S801, the CPU 301 stores the result acquired by the first document detection processing (step S800), as an initial value. Next, in step S802, the CPU 301 acquires a document detection result by executing the second document detection processing. The details of the second document detection unit will be described below. The CPU 301 uses the initial value stored in step S801 in the second document detection processing (step S802). In a case where the result acquired in the second document detection processing (step S802) indicates TRUE (YES in step S803), the processing proceeds to step S804. In step S804, the CPU 301 determines the initial value acquired in step S801, as a document detection result, and ends the document detection processing. In a case where the result acquired in the second document detection processing (step S802) indicates FALSE (NO in step S803), the CPU 301 redoes from the execution (step S800) of the first document detection processing. That is, in a case where the result of the second document detection processing indicates FALSE, a document detection result is not determined.

### First Document Detection Processing

Next, the first document detection processing in step S800 will be described. The first document detection processing is performed by the chattering elimination device 229 to which the document detection sensor 204 is connected. In the first document detection processing, in step S810, the chattering elimination device 229 acquires logic input to a port to which the document detection sensor 204 is connected (signal indicating that a document is placed/that no document is placed). Here, the chattering elimination device 229 acquires the logic of the document detection sensor 204 two consecutive times. The chattering elimination device 229 according to the present embodiment performs chattering elimination processing at a μsec-based cycle of about 0.2 μsec, and acquires logic in two consecutive cycles. The cycle at which the chattering elimination device 229 acquires the logic of the document detection sensor 204 is an example of a first cycle, and is not limited to 0.2 μsec, and may be set to an arbitrary cycle.

After that, in step S811, the chattering elimination device 229 determines whether the acquired logic remains the same two consecutive times. In a case where the acquired logic remains the same two consecutive times (YES in step S811), the processing proceeds to step S812. In step S812, the logic is determined as a result of the first document detection processing. For example, in a case where a signal indicating that a document is placed is received two consecutive times, or a signal indicating that no document is placed is received two consecutive times, a result of the first document detection processing is determined. In a case where the logic acquired two consecutive times is different (NO in step S811), the processing returns to step S810, and the processing is repeated from step S810.

That is, in a case where an output (logic) cyclically acquired from the document detection sensor 204 remains the same a plurality of consecutive times, the chattering elimination device 229 notifies the CPU 301 of the output. For example, if the logic cyclically received from the document detection sensor 204 indicates that no document is placed (OFF), two consecutive times, the chattering elimination device 229 transmits a signal indicating that no document is placed, to the CPU 301. On the other hand, in a case where outputs received from the document detection sensor 204 two consecutive times are different, the chattering elimination device 229 does not transmit the outputs to the CPU 301. For example, in a case where logic cyclically received from the document detection sensor 204 indicates that no document is placed, and then indicates that a document is placed, the chattering elimination device 229 does not transmit a signal indicating that a document is placed, to the CPU 301. Here, the "two times" in step S811 of the first document detection processing serve as an example of a first predetermined number of times, and the first predetermined number of times may be set to an arbitrary number of times equal to or larger than two.

### Second Document Detection Processing

Next, the second document detection processing in step S802 will be described. The second document detection processing is processing to be executed by the CPU 301. First of all, in step S820, the CPU 301 initializes a counter to be used in the second document detection processing, to zero. Next, in step S821, the CPU 301 executes the above-described first document detection processing using the chattering elimination device 229, and acquires the detection result.

Next, in step S822, the CPU 301 determines whether the detection result acquired in step S821 is the same as the initial value stored in step S801. In a case where the initial value stored in step S801 and the detection result acquired in step S821 are the same (YES in step S822), the processing proceeds to step S823. In step S823, the CPU 301 increments the counter. Next, in step S824, the CPU 301 waits for 2 msec.

After that, in step S825, the CPU 301 determines whether the counter indicates 10 or more. In a case where it is determined in step S825 that the counter indicates 10 or more (YES in step S825), the processing proceeds to step S826. In step S826, the CPU 301 sets TRUE as a returned value. In a case where it is determined in step S825 that the counter indicates a number less than 10 (NO in step S825), the processing returns to step S821, and the CPU 301 repeats the processing from step S821. In addition, in a case where it is determined in step S822 that the initial value stored in step S801 and the detection result acquired in step S821 are different (NO in step S822), the processing proceeds to step S827. In step S827, the CPU 301 sets FALSE as a returned value. The returned values set in steps S826 and S827 are to be used in the determination in step S803.

That is, in a case where signals acquired from the chattering elimination device 229 remain the same a plurality of consecutive times, the CPU 301 determines a document detection result. In the present embodiment, the confirmation of a first document detection result in the second document detection processing is performed every 2 msec. More specifically, the CPU 301 receives signals from the chattering elimination device 229 at the cycle of 2 msec, and determines whether the logic remains the same ten times or more. Here, 2 msec is an example of a second cycle. The second cycle is not limited to a specific time, and the second cycle may be set to an arbitrary cycle. In addition, a number indicated by the counter that is to be used in the determination in step S825 is an example of a second predetermined number of times. The second predetermined number of times is not limited to 10, and the second predetermined number of times may be set to an arbitrary number of times equal to or larger than 2.

### Description of Chattering Elimination Effect in Present Embodiment

First of all, an effect of the first document detection processing that is to be obtained by the chattering elimination device 229 will be described. As described with reference to FIGS. 6A and 6B, the document detection sensor 204 according to the present embodiment is configured to change an output depending on whether the swinging flag member 501 blocks the optical path of the photointerrupter 502. In the case of such a case, immediately after a document is placed on the document tray 201, the position of the flag member 501 is unstable, and the output of the document detection sensor 204 sometimes fluctuates.

In contrast to this, in the present embodiment, only in a case where outputs of the document detection sensor 204 consecutively remain the same the first predetermined number of times, the signal is transmitted by the chattering elimination device 229 to the CPU 301. For this reason, even in a state in which the position of the flag member 501 is unstable, it is possible to prevent logic different from an actual state, from being transmitted to the CPU 301.

On the other hand, although the chattering elimination device 229 can reduce erroneous detection caused by physical swinging of the flag member 501, as described with reference to FIG. 11C, a signal from the chattering elimination device 229 to the CPU 301 sometimes fluctuates due to radiated noise from an external environment. In view of the foregoing, in the present embodiment, the second document detection processing is executed by the CPU 301. A chattering elimination effect of the second document detection processing will be described with reference to FIGS. 11C -11E. FIG. 11E illustrates an output result to be transmitted by the CPU 301 to the CPU 311 in a case where the CPU 301 executes the second document detection processing in a case where the electric signal in FIG. 11C is output.

As described above, in the example illustrated in FIG. 11C, chattering occurs in the A section from the timings 1102 to 1103. Nevertheless, as described above, even if a document on the document tray 201 runs out at the timing 1101, the CPU 301 does not immediately notify that no document is placed. The CPU 301 determines a document detection result after executing the second document detection processing in FIG. 8C. For this reason, a timing at which a document detection result is determined becomes a timing 1104 in FIG. 11E, and the timing 1104 is a timing after 20 msec or more from the timing 1101 because at least 20 msec corresponding to 2 msec × ten determination times is required.

After that, the CPU 301 receives an electric signal indicating that a document is placed, from the document detection sensor 204 at the timing 1102. As described above, the electric signal indicating that a document is placed that is received at the time is caused by chattering, and actually, a document is not placed on the document tray 201. Nevertheless, after the lapse of the A section, the CPU 301 receives an electric signal indicating that no document is placed, from the document detection sensor 204 at the timing 1103. Thus, the CPU 301 never erroneously determines a document detection result indicating that a document is placed, by the second document detection processing. In this manner, the CPU 301 determines a document detection result in a case where signals from the chattering elimination device 229 consecutively remain the same the second predetermined number of times. For this reason, even in a case where an influence is exerted from an external environment, the CPU 301 can transmit a correct detection result to the CPU 311. That is, by the control according to the present embodiment, it is possible to reduce erroneous detection of the document detection sensor 204 that is caused by an influence from an external environment.

In the present embodiment, the description has been given of an example in which the first cycle is 0.2 μsec, the second cycle is 2 msec, the first predetermined number of times is two, and the second predetermined number of times is ten. That is, the second cycle is longer than the first cycle, and the second predetermined number of times is larger than the first predetermined number of times. With this configuration, it is possible to eliminate chattering of 0.4 μsec or more and 0.6 μsec or less that has been exemplified in FIG. 8C.

### Modified Example 1

Hereinafter, a modified example of the present embodiment will be described. The above-described second document detection processing assumes an influence from an ambient environment where an apparatus is installed. For this reason, depending on an installation environment of an apparatus, the execution of the second document detection processing is unnecessary in some cases. In view of the foregoing, the user (or serviceman) may be enabled to set whether to execute the second document detection processing.

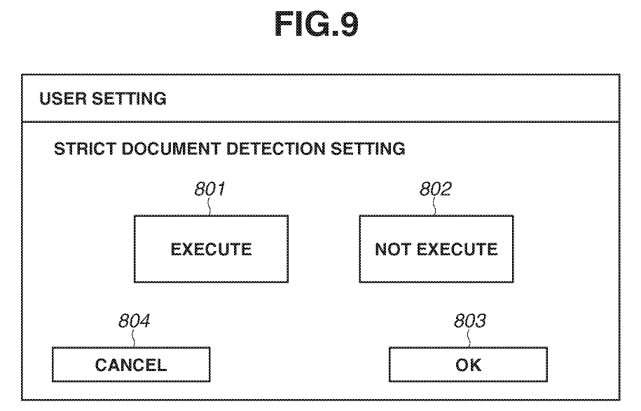

FIG. 9 illustrates an example of a setting screen for setting whether to execute strict document detection. Here, the strict document detection indicates the second document detection processing. The setting screen illustrated in FIG. 9 is displayed on the display 91 of the operation unit 90. On the setting screen illustrated in FIG. 9, an "EXECUTE" button 801, a "NOT EXECUTE" button 802, an "OK" button 803, a "CANCEL" button 804, and the like are displayed. In a case where the "OK" button 803 is pressed in a state in which the "EXECUTE" button 801 is selected, the CPU 301 enables the second document detection processing. That is, a mode of executing the document detection processing described with reference to FIGS. 8A-8C is caused.

On the other hand, in a case where the "OK" button 803 is pressed in a state in which the "NOT EXECUTE" button 802 is selected, the CPU 301 disables the second document detection processing. That is, a mode of not executing the second document detection processing is caused. Here, in one embodiment, the mode of not executing the second document detection processing is a mode of omitting the processing in step S802 (steps S820 to S827 in FIG. 8C) and step S803 in FIG. 8A, and is a mode of determining a document detection result only by the first document detection processing. In a case where the "CANCEL" button 804 is pressed, the CPU 301 maintains the current setting without changing the setting of strict document detection.

In this manner, a first mode that executes both of the first and second document detection processing, and a second mode that executes the first document detection processing without executing the second document detection processing may be selectable. With such a configuration, it is possible to simplify the control of document detection in an environment with small influence on document detection, and perform strict detection in an environment with large influence on document detection, and it becomes possible to execute appropriate control in accordance with an environment where an apparatus is installed.

### Modified Example 2

Next, another modified example of the present embodiment will be described. An influence on document detection from an ambient environment of an apparatus changes depending on radiated noise from the surrounding. For this reason, a numerical value of the counter (step S825 of FIG. 8C) that is to be used in the determination in the second document detection processing may be made settable to an arbitrary number. That is, the user may be enabled to arbitrarily set the second predetermined number of times.

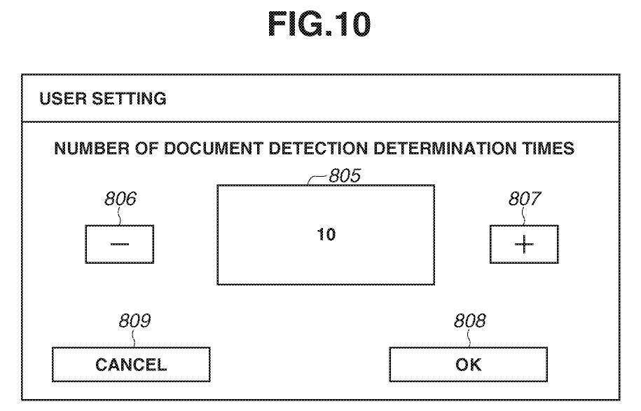

FIG. 10 illustrates a screen for setting the number of document detection determination times. Here, the number of document detection determination times indicates the second predetermined number of times. The screen illustrated in FIG. 10 is displayed on the display 91 of the operation unit 90. On the setting screen illustrated in FIG. 10, a determination number display portion 805, a minus button 806, a plus button 807, an "OK" button 808, a "CANCEL" button 809 and the like are displayed.

The determination number display portion 805 indicates the currently-set number of document detection determination times (or the number of document detection determination times to be set from now). If the minus button 806 is pressed, a numerical value in the determination number display portion 805 decreases, and if the plus button 807 is pressed, a numerical value in the determination number display portion 805 increases. By changing a numerical value in the determination number display portion 805 to a desired numerical value and pressing the "OK" button 808, the user can set the number of document detection determination times.

The CPU 301 executes the second document detection processing based on the number of document detection determination times set on the screen illustrated in FIG. 10. Specifically, the number of times of determination in step S825 of FIG. 8C is set to the number of document detection determination times set on the screen illustrated in FIG. 10. In a case where the "CANCEL" button 809 is pressed, the CPU 301 maintains the current setting without changing the number of document detection determination times.

In this manner, the second predetermined number of times to be used in the second document detection processing may be made settable to an arbitrary number. With such a configuration, it becomes possible to execute appropriate control in accordance with an environment where an apparatus is installed.

The above-described embodiment and modified examples are obtained by applying the present disclosure to the document detection processing in the document detection sensor 204 of the ADF 200, but the present disclosure is not limited to this. For example, the present disclosure can also be applied to a sheet detection sensor that detects the sheet S on the manual feed tray 1037e. In this case, a sheet detection sensor having a similar configuration to the document detection sensor 204 is arranged on the manual feed tray 1037e, and the CPU 311 executes processing similar to the above-described document detection processing. Then, the image forming unit 1033 serving as an image formation unit forms an image on the sheet S fed from the manual feed tray 1037e.

According to the above-described embodiment and modified examples, it is possible to reduce erroneous detection of a sheet detection sensor that is caused by an influence from an external environment.

According to the present disclosure, it is possible to provide a sheet feeding apparatus, an image reading apparatus, and an image forming apparatus that can prevent the occurrence of erroneous detection of a sheet on a feeding tray.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-067551, filed Apr. 16, 2025, which is hereby incorporated by reference herein in its entirety.

What is claimed is:

1. An apparatus comprising:
a feeding tray on which a sheet is to be placed;
a feeding member configured to feed a sheet placed on the feeding tray;
a sensor configured to detect presence or absence of a sheet on the feeding tray;
an elimination device configured to eliminate chattering of a signal to be output by the sensor; and
a controller configured to control the feeding member based on presence or absence of a sheet on the feeding tray,
wherein the sensor includes an emission unit, a receiving unit that receives light from the emission unit, and a swinging member that swings by being pressed by a sheet placed on the feeding tray, and transmits, to the elimination device, a signal indicating one of a state in which the swinging member blocks light from the emission unit to the receiving unit, and a state in which the swinging member does not block light from the emission unit to the receiving unit,
wherein the elimination device cyclically acquires a signal from the sensor at a first cycle, and in a case where signals from the sensor consecutively remain the same a first predetermined number of times equal to or larger than two, the elimination device executes first processing of transmitting a signal from the sensor to the controller, and
wherein the controller cyclically acquires a signal from the elimination device at a second cycle, and in a case where signals from the elimination device consecutively remain the same a second predetermined number of times equal to or larger than two, the controller executes second processing of determining information indicating presence or absence of a sheet on the feeding tray.

2. The apparatus according to claim 1, wherein the second cycle is longer than the first cycle.

3. The apparatus according to claim 1, wherein the second predetermined number of times is larger than the first predetermined number of times.

4. The apparatus according to claim 1, wherein, as a mode of detecting a sheet by the sensor, a first mode of executing the first processing and not executing the second processing, and a second mode of executing both of the first processing and the second processing are executable.

5. The apparatus according to claim 4, further comprising an operation unit that can select the first mode and the second mode as a mode of detecting a sheet by the sensor.

6. The apparatus according to claim 1, further comprising an operation unit that can set the second predetermined number of times.

7. The apparatus according to claim 1, wherein the elimination device is a substrate and the controller is a central processing unit (CPU).

8. An apparatus comprising:
a feeding tray on which a sheet is to be placed;
a feeding member configured to feed a sheet placed on the feeding tray;
a sensor configured to detect presence or absence of a sheet on the feeding tray;
an elimination device configured to eliminate chattering of a signal to be output by the sensor;
a controller configured to control the feeding member based on presence or absence of a sheet on the feeding tray; and
a reading unit configured to read an image on a sheet fed by the feeding member,
wherein the sensor includes an emission unit, a receiving unit that receives light from the emission unit, and a swinging member that swings by being pressed by a sheet placed on the feeding tray, and transmits, to the elimination device, a signal indicating one of a state in which the swinging member blocks light from the emission unit to the receiving unit, and a state in which the swinging member does not block light from the emission unit to the receiving unit,
wherein the elimination device cyclically acquires a signal from the sensor at a first cycle, and in a case where signals from the sensor consecutively remain the same a first predetermined number of times equal to or larger than two, the elimination device executes first processing of transmitting a signal from the sensor to the controller, and
wherein the controller cyclically acquires a signal from the elimination device at a second cycle, and in a case where signals from the elimination device consecutively remain the same a second predetermined number of times equal to or larger than two, the controller executes second processing of determining information indicating presence or absence of a sheet on the feeding tray.

9. The apparatus according to claim 8, wherein the second cycle is longer than the first cycle.

10. The apparatus according to claim 8, wherein the second predetermined number of times is larger than the first predetermined number of times.

11. The apparatus according to claim 8, wherein, as a mode of detecting a sheet by the sensor, a first mode of executing the first processing and not executing the second processing, and a second mode of executing both of the first processing and the second processing are executable.

12. The apparatus according to claim 11, further comprising an operation unit that can select the first mode and the second mode as a mode of detecting a sheet by the sensor.

13. The apparatus according to claim 8, further comprising an operation unit that can set the second predetermined number of times.

14. The apparatus according to claim 8, wherein the elimination device is a substrate and the controller is a central processing unit (CPU).

15. An apparatus comprising:
a feeding tray on which a sheet is to be placed;
a feeding member configured to feed a sheet placed on the feeding tray;
a sensor configured to detect presence or absence of a sheet on the feeding tray;
an elimination device configured to eliminate chattering of a signal to be output by the sensor;
a controller configured to control the feeding member based on presence or absence of a sheet on the feeding tray; and
a forming unit configured to form an image on a sheet fed by the feeding member,
wherein the sensor includes an emission unit, a receiving unit that receives light from the emission unit, and a swinging member that swings by being pressed by a sheet placed on the feeding tray, and transmits, to the elimination device, a signal indicating one of a state in which the swinging member blocks light from the emission unit to the receiving unit, and a state in which the swinging member does not block light from the emission unit to the receiving unit,
wherein the elimination device cyclically acquires a signal from the sensor at a first cycle, and in a case where signals from the sensor consecutively remain the same a first predetermined number of times equal to or larger than two, the elimination device executes first processing of transmitting a signal from the sensor to the controller, and
wherein the controller cyclically acquires a signal from the elimination device at a second cycle, and in a case where signals from the elimination device consecutively remain the same a second predetermined number of times equal to or larger than two, the controller executes second processing of determining information indicating presence or absence of a sheet on the feeding tray.

16. The apparatus according to claim 15, wherein the second cycle is longer than the first cycle.

17. The apparatus according to claim 15, wherein the second predetermined number of times is larger than the first predetermined number of times.

18. The apparatus according to claim 15, wherein, as a mode of detecting a sheet by the sensor, a first mode of executing the first processing and not executing the second processing, and a second mode of executing both of the first processing and the second processing are executable.

19. The apparatus according to claim 18, further comprising an operation unit that can select the first mode and the second mode as a mode of detecting a sheet by the sensor.

20. The apparatus according to claim 15, further comprising an operation unit that can set the second predetermined number of times.
